(19) United States
(12) Patent Application Publication
(10) Pub. No.: US 2021/0056518 A1
(43) Pub. Date: Feb. 25, 2021

(54) AUTHENTICATION CREDENTIAL SYSTEM

(71) Applicant: Wells Fargo Bank, N.A., Charlotte, NC (US)

(72) Inventors: Jinee K. Ellis, San Francisco, CA (US); Priyamvada Singh, San Francisco, CA (US); Beth S. Moss, Danville, CA (US)

(21) Appl. No.: 14/976,676

(22) Filed: Dec. 21, 2015

(51) Int. Cl. G06Q 20/02; G06Q 20/40

(52) U.S. Cl. CPC G06Q 20/027; G06Q 20/4016

(57) ABSTRACT

A system and method of leveraging a trust relationship for e-commerce transactions is provided that includes an access component allowing a consumer access to a merchant website, a selection component allowing the consumer to enter authentication credentials associated with a third party on the merchant website, an authentication component authenticating the authentication credentials for the third party entered into the merchant website, a communication interface component allowing an association of the consumer's payment account information from the third party to the merchant website, and a consummation component allowing consummation of an electronic transaction between the third party and the merchant.

### BACKGROUND

Currently if a consumer chooses to pay a bill electronically through a merchant's website, the consumer most often must create an account for that merchant and login to the merchant's website. Thus, the consumer must have authentication credentials for the merchant's website. One disadvantage to this system is that the consumer must create an account and authentication credentials for each and every on-line merchant that the consumer patronizes. Another disadvantage is that the consumer must also enter or re-enter payment information for each on-line merchant.

Another disadvantage is that the merchant must have and maintain an authentication service to their consumers. In addition, in order to determine if the consumer transactions are legit or fraudulent, the merchant must also have and maintain a fraud monitoring system to monitor consumer transactions.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In an aspect of the innovation, disclosed herein is a system that leverages a trust relationship for e-commerce transactions that includes an access component allowing a consumer access to a merchant website, a selection component allowing the consumer to enter authentication credentials associated with a third party on the merchant website, an authentication component authenticating the authentication credentials for the third party entered into the merchant website, a communication interface component allowing an association of the consumer's payment account information from the third party to the merchant website, and a consummation component allowing consummation of an electronic transaction between the third party and the merchant.

In another aspect of the innovation, disclosed herein is a method of leveraging a financial institutions trust relationship to enhance a consumer banking experience that includes accessing a merchant website by a consumer, entering consumer's authentication credentials associated with a financial institution into the merchant website, authenticating consumer's authentication credentials entered into the merchant website by the financial institution, communicating consumer payment account information to the merchant website from the financial institution, and consummating an electronic transaction between the merchant website and the financial institution.

In another aspect of the innovation, disclosed herein is a method of transferring an electronic payment that includes accessing a merchant website by a consumer, entering consumer's authentication credentials associated with consumer's financial institution into the merchant website, authenticating consumer's authentication credentials entered into the merchant website by the financial institution, communicating consumer default payment information from the consumer's financial institution to the merchant website, and transferring an electronic payment from the consumer's financial institution to the merchant website.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is a block diagram illustration of an e-commerce system in accordance with an aspect of the innovation.

FIG. 2 is a non-limiting illustration of an authentication system shown in block diagram form respectively in accordance with an aspect of the innovation.

FIGS. 3-7 are non-limiting illustrations of the components of the authentication system illustrated in FIG. 2 in accordance with an aspect of the innovation.

FIGS. 8A and 8B illustrate example, non-limiting block diagrams of a method of facilitating electronic transactions in accordance with an aspect of the innovation.

FIG. 9 illustrates an example, non-limiting computer-readable medium or computer-readable device including processor-executable instructions configured to embody one or more of the aspects set forth herein.

FIG. 10 illustrates an example, non-limiting computing environment where one or more of the aspects set forth herein are implemented, according to one or more aspects.

### DETAILED DESCRIPTION

The innovation is now described with reference to the drawings. In the following description, for purposes of explanation, numerous specific details are set forth in order to provide a thorough understanding of the subject innovation. It may be evident, however, that the innovation may be practiced without these specific details. In other instances, well-known structures and devices are shown in block diagram form in order to facilitate describing the innovation.

As used herein, the term “inference” or “infer” refers generally to the process of reasoning about or inferring states of the system, a component, a module, the environment, and/or user devices from a set of observations as captured through events, reports, data and/or through other forms of communication. Inference may be employed to identify a specific context or action, or may generate a probability distribution over states, for example. The inference may be probabilistic. For example, computation of a probability distribution over states of interest based on a consideration of data and/or events. The inference may also refer to techniques employed for composing higher-level events from a set of events and/or data. Such inference may result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) may be employed in connection with performing automatic and/or inferred action in connection with the disclosed aspects.

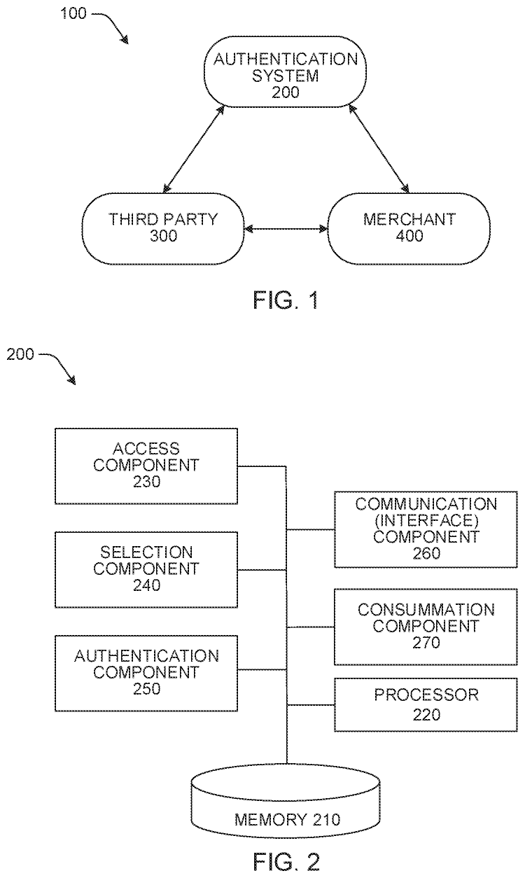

Referring now to the drawings, FIG. 1 is a block diagram illustration of an e-commerce system 100 incorporating an innovative authentication system 200 that addresses the above mentioned disadvantages and enhances a consumer banking experience by leveraging a third party's (e.g., consumer's financial institution) 300 trust relationship with consumers and merchants (e.g., on-line merchants) 400 that accept electronic payments from the consumer. On-line merchants may include E-billers/E-creditors, such as but not limited to the gas company, the electric company, the phone company, the cable company, etc. and any other on-line merchants that sell goods and/or services. The authentication system 200 is configured to provide a means for a consumer to login to a merchant's website 400 using their financial institutions authentication credentials in order to conduct electronic business (e.g., paying a bill, checking balances, etc.) on the merchant's website 400. The authentication system 200 is a benefit to the consumer because the consumer no longer has to create multiple accounts and authentication credentials for each on-line merchant 400 that they patronize.

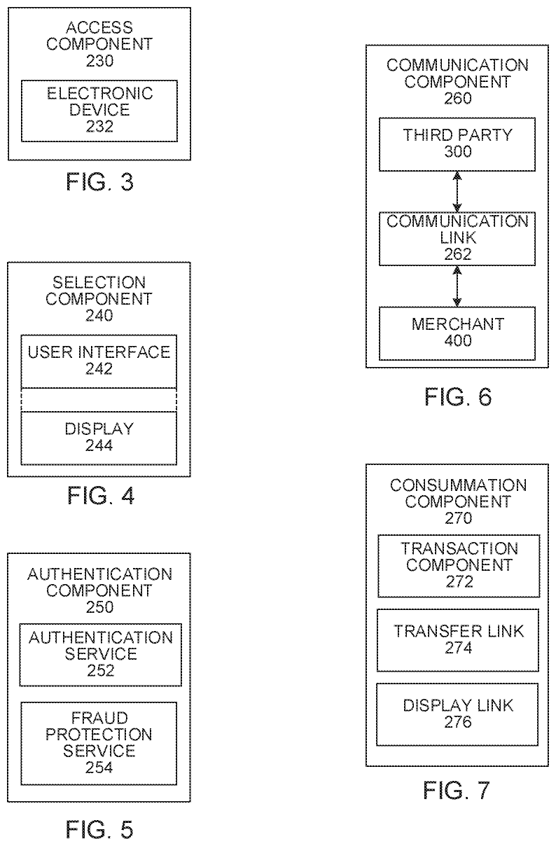

FIG. 2 is a block diagram illustration of the authentication system 200 in accordance with an aspect of the innovation. The authentication system 200 may include at least one memory 210 that may store computer executable components and/or computer executable instructions. The authentication system 200 may also include at least one processor 220, communicatively coupled to the at least one memory 210. The at least one processor 220 may facilitate execution of the computer executable components and/or the computer executable instructions stored in the memory 210. The term “coupled” or variants thereof may include various communications including, but not limited to, direct communications, indirect communications, wired communications, and/or wireless communications (e.g., with specialized banking machines and systems).

It is noted that although the one or more computer executable components and/or computer executable instructions may be illustrated and described herein as components and/or instructions separate from the memory 210 (e.g., operatively connected to the memory 210), the various aspects are not limited to this implementation. Instead, in accordance with various implementations, the one or more computer executable components and/or the one or more computer executable instructions may be stored in (or integrated within) the memory 210. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple specialized components and/or as multiple instructions without departing from the example embodiments.

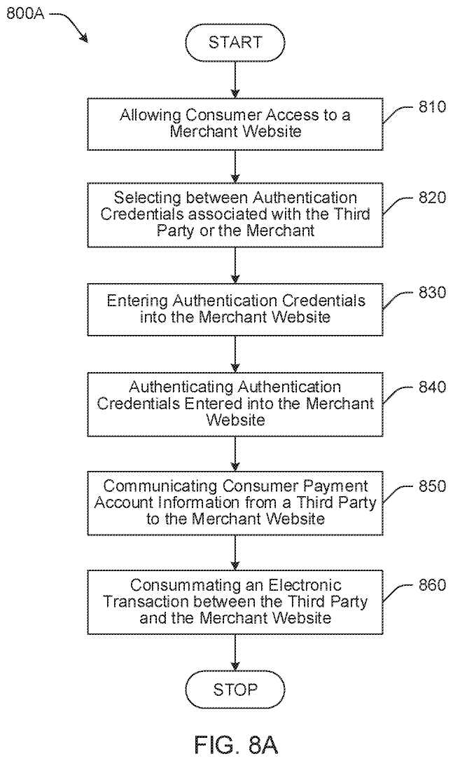

Referring to FIGS. 2 and 3, the authentication system 200 may include an access component 230 that provides a consumer access to a merchant website 400 in accordance with an aspect of the innovation. The access component 230 can be a wired or wireless device that has access to the internet to provide the consumer a means to access the merchant website. For example, the access component 230 may be comprised of an electronic device 232 (e.g., computer, laptop, etc.) or a remote portable electronic device (e.g., phone, tablet, etc.) having the capability to access the merchant's website.

Referring to FIGS. 2 and 4, the authentication system 200 may further include a selection component 240 in accordance with an aspect of the innovation. The selection component 240 can include a user interface 242 (e.g., key pad, touch screen, etc.) that allows the consumer to enter authentication credentials (e.g., user ID, password, security questions, etc.). The selection component 240 may further include a display 244 that may or may not be integrated (dashed line in FIG. 4 represents integration) with the user interface 242 that provides a visualization means for the consumer. The display 244 may be able to display a dashboard (e.g., a consolidated Business Process Management (BPM) dashboard) that has the capability display any information relating to electronic transactions of the consumer, such as but not limited to, payment options, account balances, payment confirmation data, etc.

The user interface 242 is configured such that the consumer can select from multiple authentication credentials in order to login to the merchant website 400. For example, the consumer can login using authentication credentials associated with the merchant from a merchant account that the consumer created. On the other hand, the consumer can login using authentication credentials associated with a third party (e.g., financial institution, such as but not limited to a bank, credit union, etc.) from an account created by the consumer. It is to be understood that the selection of login authentication credentials is not limited to the merchant or that of a financial institution. The consumer can login using any predetermined/preapproved third party authentication credentials that may link the third party entity to the merchant website to perform transactions as disclosed herein.

In one embodiment, the consumer can enter the third party authentication credentials on a home a (main) page of the merchant website thus, allowing the consumer access to the entire merchant website. In other embodiments, the consumer may have limited access to certain sections of the merchant website, such as but not limited to a bill pay section, an account balance section etc. when logging in using the third party authentication credentials. For example, the consumer may enter the third party authentication credentials on the home page, but then be redirected to the limited access section or sections once entered. In another example, the consumer may be redirected to the limited access section or sections prior to entering the third party authentication credentials and enter the credentials in the limited access section.

Referring to FIGS. 2 and 5, the authentication system 200 may further include an authentication component 250 in accordance with an aspect of the innovation. The authentication component 250 can include an authentication service 252 that determines if the authentication credentials (e.g., user ID, password, security question answers, etc.) entered by the consumer match the authentication credentials on the merchant's and/or third party's main computer system (e.g., are authentic). One benefit to the merchant of the innovative authentication system 200 disclosed herein is that having consumers use their third party authentication credentials, then the merchant does not have to maintain an authentication service. In addition, the authentication component 250 may include a fraud protection service 254 that monitors transactions to detect if the transactions are legitimate or fraudulent. Thus, another benefit to the merchant is that the merchant does not have to maintain the fraud protection service 254. Both the authentication service and the fraud protection service 252, 254 can be maintained by the third party.

Referring to FIGS. 2 and 6, the authentication system 200 may further include a communication component 260 in accordance with an aspect of the innovation. The communication component 260 provides a communication link 262 between consumer information (e.g., payment options) in the third party computer system 300 and the merchant website 400. For example, the communication link 262 may be in the form of an interface (e.g., Application Program Interface (API)) that facilitates communication between the third party system 300 and the merchant's website 400. The interface 262 may be integrated into the merchant website 400, but managed by the third party 300 and associates the merchant 400 with consumer payment accounts/options via the third party infrastructure 300. Thus, in one embodiment, the communication component 260 can automatically populate consumer payment options (e.g., credit card information, bank account information, etc.) onto the merchant website 400, for example, onto the bill pay section of the merchant website 400.

Referring to FIGS. 2 and 7, the authentication system 200 may further include a consummation component 270 in accordance with an aspect of the innovation. The consummation component 270 can include a transaction component 272 that facilitates an electronic transaction between the third party 300 and the merchant 400. An electronic transfer link 274 may be provided that facilitates an electronic transfer of payment funds from the third party 300 to the merchant 400. The consummation component 270 can further include a display link 276 that transfers information to the display 244. Thus, the display 244 can display the electronic transaction (e.g., electronic payment) process and the confirmation of the electronic transaction on the display 244.

In an alternative embodiment, the merchant website can be embedded into the third party's system (website). In other words, a merchant can embed their site within the third party website such that, once logged into the third party website, a consumer can select from a number of different merchants (providers) for activity such as bill payment, account balance, etc. where the system automatically populates with the consumer's payment account information. This configuration may provide the third party the ability to leverage the trust they've gained from their customers to help promote e-payments/billing.

The innovative authentication system disclosed herein offers many benefits to the consumer, the merchant and to the financial institution. For example, the consumer does not have to create multiple merchant accounts and, thus, does not need to have multiple authentication credentials. In addition, the consumer does not have to enter and re-enter payment options into the merchant website every time the consumer wishes to make an electronic payment. Still further, the consumer does not have to store their financial information on multiple merchant websites.

Regarding the merchant, since the financial institution would own and manage the authentication service, the merchant can leverage the authentication service without having to develop their own. Further, the merchant would not have to retain and manage sensitive consumer information. Still further, since the financial institution would also maintain a fraud protection service, the merchant would not have to develop their own. In addition, the merchant would have access to any programs, services, etc. that the financial institution has to offer.

The financial institution can more easily track purchasing/spending habits and information of their consumers. This allows the financial institution to analyze purchasing/spending habits and create/offer personal financial management or budget tools to the consumer. In addition, by monitoring the purchases of the consumer, the financial institution can more easily monitor an array of possible fraud scenarios. Still further, the financial institution can leverage this information to enhance the consumer banking experience. For example, if consumer buys airline ticket, the financial institution would have all the information relating to destination, departure, arrival, and return dates, etc. Thus, if the consumer made a purchase in the destination city during the scheduled time frame, the financial institution, knowing that the consumer is in the destination city, can approve the purchase without contacting the consumer to make sure that the consumer is the actual purchaser.

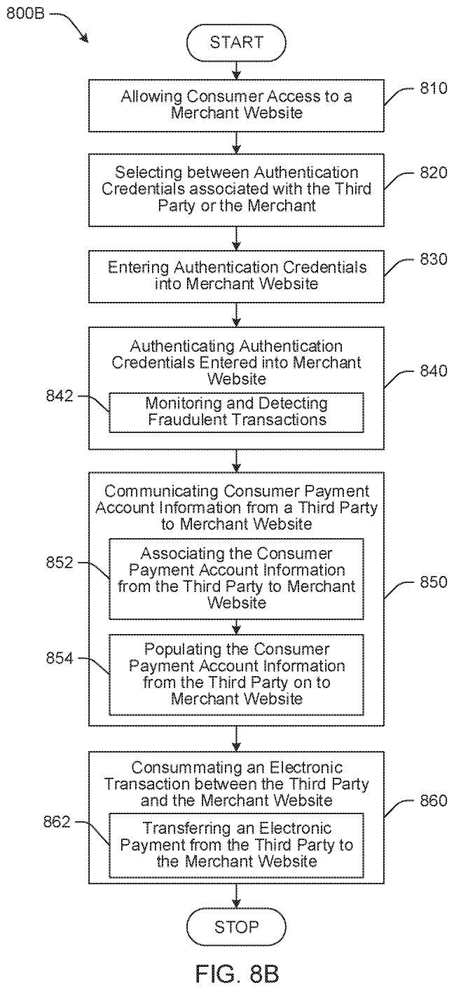

Referring to FIGS. 8A and 8B, methods that may be implemented in accordance with the disclosed subject matter will be better appreciated with reference to the flow charts. While, for purposes of simplicity of explanation, the methods are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the disclosed methods. It is to be appreciated that the functionality associated with the blocks may be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods might alternatively be represented as a series of interrelated states or events, such as in a state diagram.

The various aspects (e.g., in connection with automatic implementation of various portions of actions/events, completion of a prior action/event, and so forth) may employ various artificial intelligence-based schemes for carrying out various aspects thereof. For example, a process for determining if a particular action should follow a current action may be enabled through an automatic classifier system and process.

A classifier is a function that maps an input attribute vector, x=(x1, x2, x3, x4, xn), to a confidence that the input belongs to a class. In other words, f(x)=confidence (class). Such classification may employ a probabilistic and/or statistical-based analysis (e.g., factoring into the analysis utilities and costs) to forecast or infer an action that should be employed to determine what actions should be automatically performed what actions should be performed after receiving confirmation from the user to proceed. In the case of actions/events, for example, attributes may be identification of a user device and/or the user and the classes are criteria related to known information (e.g., historical information) about the user device and/or user.

A support vector machine (SVM) is an example of a classifier that may be employed. The SVM operates by finding a hypersurface in the space of possible inputs, which hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein, may be inclusive of statistical regression that is utilized to develop models of priority.

One or more aspects may employ classifiers that are explicitly trained (e.g., through a generic training data) as well as classifiers that are implicitly trained (e.g., by observing fraud trends, by receiving extrinsic information, and so on). For example, SVM's may be configured through a learning or training phase within a classifier constructor and feature selection module. Thus, a classifier(s) may be used to automatically learn and perform a number of functions, including but not limited to determining according to a predetermined criteria when to provide a suggested action (e.g., take medication), when to complete a current action, which actions to implement in sequence, and so forth. The criteria may include, but is not limited to, historical information, user preferences, expected actions, and so forth.

Additionally or alternatively, an implementation scheme (e.g., a rule, a policy, and so on) may be applied to control and/or regulate events and resulting recommendations, subsequent events, and so forth. In some implementations, based upon a predefined criterion, the rules-based implementation may automatically and/or dynamically implement one or more portions of an event/action. In response thereto, the rule-based implementation may automatically interpret and carry out functions associated with the event/action by employing a predefined and/or programmed rule(s) based upon any desired criteria.

FIGS. 8A and 8B are non-limiting block diagram illustrations 800A, 800B of a method of enhancing a consumer's banking experience by leveraging the consumer's financial institutions trust relationship with merchants in accordance with an aspect of the innovation. Referring to FIG. 8, at 810, the consumer accesses the merchant website 400. At 820, the consumer selects between entering authentication credentials associated with the third party (e.g., consumer's financial institution) 300 or authentication credentials associated with the merchant 400. At 830, the consumer enters authentication credentials associated with the consumer's financial institution into merchant website. At 840, the consumer's financial institution authenticates the consumer's authentication credentials entered into merchant website. At 850, consumer payment account information is communicated to the merchant website from the consumer's financial institution. At 860, an electronic transaction between the merchant website and the consumer's financial institution is consummated.

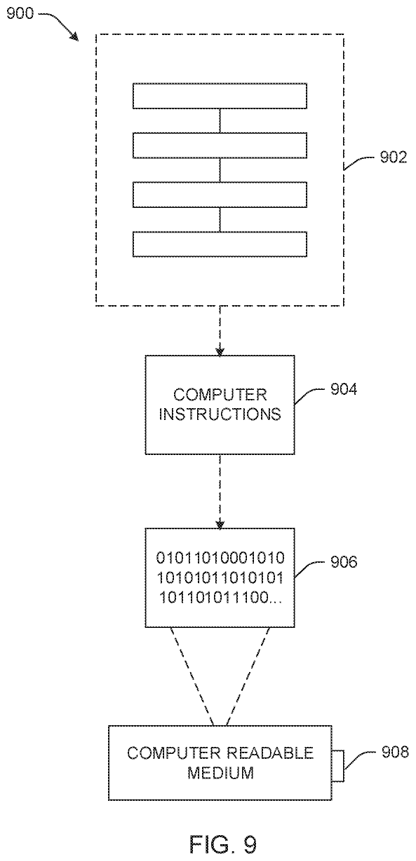

Referring to FIG. 9, authenticating the consumer's authentication credentials entered into the merchant website (840) includes, at 842, monitoring and detecting fraudulent electronic transactions. Communicating the consumer payment account information to the merchant website from the consumer's financial institution includes, at 852 associating the consumer payment account information from the consumer's financial institution to the merchant website and, at 854, populating the consumer payment account information onto the merchant website. Consummating an electronic transaction between the merchant website and the consumer's financial institution (860) includes, at 862, transferring an electronic payment from the consumer's financial institution 300 to the merchant website 400.

One or more implementations include a computer-readable medium including processor-executable instructions configured to implement one or more embodiments presented herein. An embodiment of a computer-readable medium or a computer-readable device devised in these ways is illustrated in FIG. 8, wherein an implementation 800 includes a computer-readable medium 802, such as a CD-R, DVD-R, flash drive, a platter of a hard disk drive, and so forth, on which is encoded computer-readable data 804. The computer-readable data 804, such as binary data including a plurality of zero's and one's as illustrated, in turn includes a set of computer instructions 806 configured to operate according to one or more of the principles set forth herein.

In the illustrated embodiment 800, the processor-executable computer instructions 806 may be configured to perform a method 808, such as the methods disclosed herein. In another embodiment, the processor-executable instructions 804 may be configured to implement a system, such as the systems disclosed herein. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

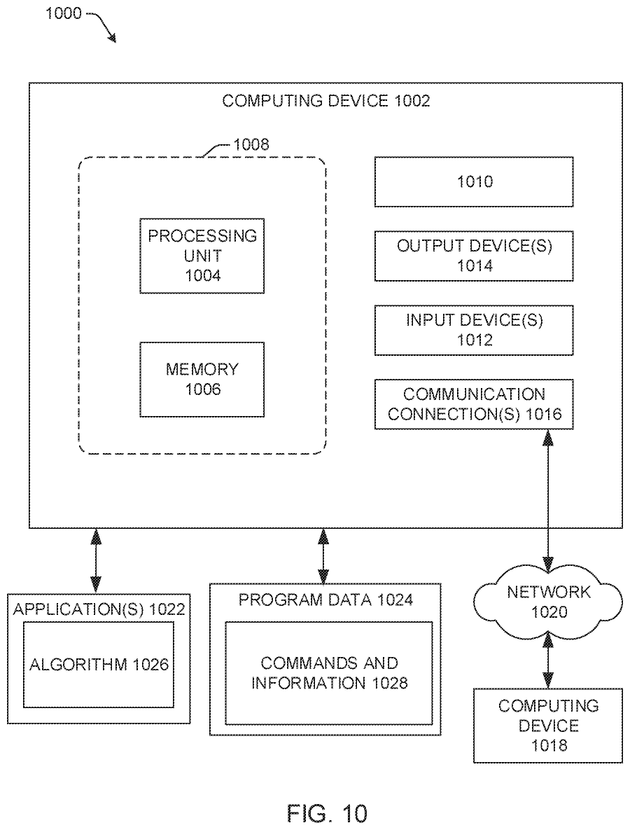

FIG. 10 and the following discussion provide a description of a suitable computing environment to implement embodiments of one or more of the aspects set forth herein. The operating environment of FIG. 10 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 10 illustrates a system 1000 that may include a computing device 1002 configured to implement one or more embodiments provided herein. In one configuration, the computing device 1002 may include at least one processing unit 1004 and at least one memory 1006. Depending on the exact configuration and type of computing device, the at least one memory 1006 may be volatile, such as RAM, non-volatile, such as ROM, flash memory, etc., or a combination thereof. This configuration is illustrated in FIG. 10 by dashed line 1008.

In other embodiments, the device 1002 may include additional features or functionality. For example, the device 1002 may include additional storage such as removable storage or non-removable storage, including, but not limited to, magnetic storage, optical storage, etc. Such additional storage is illustrated in FIG. 10 by storage 1010. In one or more embodiments, computer readable instructions to implement one or more embodiments provided herein are in the storage 1010. The storage 1010 may store other computer readable instructions to implement an operating system, an application program, etc. Computer readable instructions may be loaded in the at least one memory 1006 for execution by the at least one processing unit 1004, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The device 1002 may include input device(s) 1012 such as keyboard, mouse, pen, voice input device, touch input device, infrared cameras, video input devices, or any other input device. Output device(s) 1014 such as one or more displays, speakers, printers, or any other output device may be included with the device 1002. The input device(s) 1012 and the output device(s) 1014 may be connected to the device 1002 via a wired connection, wireless connection, or any combination thereof. In one or more embodiments, an input device or an output device from another computing device may be used as the input device(s) 1012 and/or the output device(s) 1014 for the device 1002. Further, the device 1002 may include communication connection(s) 1016 to facilitate communications with one or more other devices, illustrated as a computing device 618 coupled over a network 1020.

One or more applications 1022 and/or program data 1024 may be accessible by the computing device 1002. According to some implementations, the application(s) 622 and/or program data 1024 are included, at least in part, in the computing device 1002. The application(s) 1022 may include an algorithm 1026 that is arranged to perform the functions as described herein including those described herein. The program data 1024 may include commands and information 1028 that may be useful for operation with the system and method disclosed herein.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system that leverages a trust relationship for e-commerce transactions comprising the following components implemented on at least one hardware processor:
an access component that controls a consumer access to a merchant website;
a selection component that allows the consumer to enter authentication credentials associated with a third party on the merchant website wherein the credentials include at least a security question answer;
an authentication component that authenticates the authentication credentials for the third party entered into the merchant website;
a communication interface component that enables an association of payment account information of a customer from the third party to the merchant website; and
a consummation component that enables consummation of an electronic transaction between the third party and the merchant,
wherein the merchant website is embedded into a website of the third party such that once logged into the website of the third party the consumer can select from a number of different merchants and the third party automatically populates payment information of the consumer, wherein the third party may be a financial institution,
wherein one or more of the above functions are carried out using support vector machines explicitly or implicitly trained in order to automatically learn and perform functions according to predetermined criteria.

2. The system of claim 1, wherein the electronic transaction includes an electronic payment transfer from the third party to the merchant website.

3. The system of claim 2, wherein the third party is a consumer's financial institution.

4. The system of claim 3, wherein the customer's financial institution is that consumer's bank.

5. The system of claim 1, wherein the access component is an electronic device that facilitates access to the internet.

6. The system of claim 1, wherein the selection component allows the consumer to enter the consumer's authentication credentials associated with the merchant website.

7. The system of claim 1, wherein the selection component includes a user interface and a display that allows the consumer to enter and visualize the authentication credentials, wherein the display includes a dashboard that displays information relating to electronic transactions of the consumer, including but not limited to, payment options, account balances, and payment confirmation data, wherein the user interface allows the user to select from multiple authentication credentials in order to log into the merchant website.

8. The system of claim 1, wherein the authentication component includes an authentication service managed by the third party that determines if the authentication credentials entered into the merchant website are authentic.

9. The system of claim 1, wherein the authentication component includes a fraud protection service managed by the third party that monitors and detects fraudulent electronic transactions by the third party on the merchant website.

10. The system of claim 1, wherein the communication component includes an interface integrated into the merchant website and wherein the interface is managed by the third party to thereby establish electronic communication between the third party and the merchant website.

11. The system of claim 1, wherein the consummation component includes a transaction component and an electronic transfer link that facilitate an electronic transaction and an electronic transfer respectively of payment funds between the third party and the merchant website.

12. A method of leveraging a financial institutions trust relationship to enhance a consumer banking experience, implemented via at least one hardware processor, the method comprising:
accessing a merchant website by a consumer;
entering consumer's authentication credentials associated with a financial institution into the merchant website, wherein the credentials include at least a security question answer;
authenticating consumer's authentication credentials entered into the merchant website by the financial institution;
communicating consumer payment account information to the merchant website from the financial institution; and
consummating an electronic transaction between the merchant website and the financial institution,
wherein one or more of the above functions are carried out using support vector machines explicitly or implicitly trained in order to automatically learn and perform functions according to predetermined criteria.

13. The method of claim 12, wherein prior to entering consumer's authentication credentials associated with a financial institution into the merchant website, the method further comprises selecting between entering authentication credentials associated with the financial institution or authentication credentials associated with the merchant website.

14. The method of claim 12 further comprising monitoring and detecting fraudulent electronic transactions by the financial institution on the merchant website, wherein an authentication service is maintained by the financial institution, the authentication service being leveraged by the merchant, and offering financial management or budget tools to the consumer based on the monitoring.

15. The method of claim 12, wherein communicating consumer payment account information to the merchant website from the financial institution includes associating a consumer electronic payment option to the merchant website from the financial institution, wherein the consumer is granted access to the merchant website and then redirected to a limited access section of the merchant website.

16. The method of claim 15 further comprising populating consumer credit card information onto the merchant website.

17. The method of claim 12, wherein consummating an electronic transaction between the merchant website and the financial institution includes electronically transferring an electronic payment from the financial institution to the merchant website.

18. A method of transferring an electronic payment comprising:
accessing a merchant web site by a consumer, wherein the merchant website is embedded into a website of the consumer's financial institution such that once logged into the website of the consumer's financial institution the consumer can select from a number of different merchants and the financial institution automatically populates the payment information of the consumer;
authenticating consumer's authentication credentials entered into the merchant website by the financial institution;
and
transferring an electronic payment from the consumer's financial institution to the merchant website.

19. The method of claim 18, wherein the method is carried out using fuzzy logic.

20. The method of claim 18 further comprising monitoring and detecting fraudulent electronic transactions by the consumer's financial institution on the merchant website.

21. The system of claim 1, wherein the system employs probabilistic or statistical-based analysis to infer an action that will be employed to determine which actions will be performed automatically and which actions will be performed after receiving confirmation from the consumer to proceed.
